(19) United States
(12) Patent Application Publication
(10) Pub. No.: US 2017/0151116 A1
(43) Pub. Date: Jun. 1, 2017

(54) PATIENT POSITIONING SYSTEM

(71) Applicant: Covidien LP, Mansfield, MA (US)

(72) Inventors: Christian Baker, South Weymouth, MA (US); Erick Garstka, Westfield, MA (US); Byron Kerns, Franklin, MA (US)

(21) Appl. No.: 15/363,427

(22) Filed: Nov. 29, 2016

Related U.S. Application Data
(60) Provisional application No. 62/260,880, filed on Nov. 30, 2015.

(51) Int. Cl. A61G 13/12

(52) U.S. Cl. CPC A61G 13/1295; A61G 13/121

(57) ABSTRACT

A positioning pad for positioning a patient on an operating table includes a body, and a sheet configured to be coupled to the body. The body has a first end and a second end. The sheet is configured to be coupled to the body and is bifurcated to define a first portion and a second portion. The sheet includes a fastening member disposed on the first portion and a fastening member disposed on the second portion. The first portion is configured to be wrapped over an arm of a patient and the second portion is configured to be wrapped under an arm of a patient to secure the fastening member of the first portion to the fastening member of the second portion and secure the sheet to the arm of the patient.

### CROSS REFERENCE TO RELATED APPLICATIONS

This application claims priority to and the benefit of U.S. Provisional Patent Application No. 62/260,880, filed Nov. 30, 2015.

### BACKGROUND

1. Technical Field

The present disclosure relates to a system for securing a patient to an operating table. More specifically, the present disclosure relates to a system for immobilizing a patient on an operating table to perform a surgical procedure.

2. Background

In a variety of different surgical procedures, it is beneficial to place a patient in the Trendelenburg position. These procedures include gynecological, laparoscopic, abdominal, colorectal, urological and about 70% of robotic surgical procedures. Use of the Trendelenburg position is also quite common during gastric bypass procedures on obese patients. In the Trendelenburg position, the patient is laid flat on the back (supine position) on an inclined operating table with the patient's feet positioned higher than the patient's head at an angle of between about fifteen degrees and about thirty degrees. In this position, gravity pulls the intestines away from the pelvis to allow a clinician better access to pelvic organs.

In the Trendelenburg position, the patient's body has a tendency to slide down the inclined operating table. A variety of products and methods are used to minimize patient slippage on the operating table. In one known product, a positioning pad is provided that defines a transverse cut through which a sheet is positioned. The sheet extends through the transverse cut, is wrapped around a patient's arms, and is tucked back into the transverse cut to secure the patient to the positioning pad. In use of this product with obese patients, it has proved challenging to lift the patient to tuck the sheet back into the transverse cut. It would be desirable to provide an improved system for more securely positioning and immobilizing the patient on the operating table in the Trendelenburg and other positions.

### SUMMARY

In accordance with one aspect of the present disclosure, a positioning pad for positioning a patient on an operating table is provided and includes a body and a sheet configured to be coupled to the body. The body has a first end and a second end and may have a thickness that increases between the first end of the body and the second end of the body. Alternatively, the body may have a uniform thickness along its length. The sheet is bifurcated to define a first portion and a second portion. The sheet includes a fastening member disposed on the first portion and a fastening member disposed on the second portion. The first portion is configured to be wrapped over an arm of a patient and the second portion is configured to be wrapped under an arm of a patient to secure the fastening member of the first portion to the fastening member of the second portion and secure the sheet to the arm of the patient.

In some embodiments, the body may define a first slit, a second slit, and a transverse channel interconnecting the first and second slits. The sheet may be configured to extend through the first slit of the body, through the transverse channel of the body, and through the second slit of the body. The sheet may further include a first end extending from the first slit of the body, a second end extending from the second slit of the body, and an intermediate portion that interconnects the first end and the second end and that extends through the transverse channel of the body. The first end of the sheet may be bifurcated to define the first portion and the second portion. The second end of the sheet may also be bifurcated to define a third portion and a fourth portion of the sheet. The third portion may be configured to be wrapped over an arm of a patient and the fourth portion may be configured to be wrapped under an arm of the patient.

In some embodiments, the pad may include a first sheet and a second sheet. The first sheet may be attached to the body at a location adjacent a first lateral side of the body and the second sheet may be attached to the body at a location adjacent a second lateral side of the body. The first sheet may have a first end attached to the body, and a second end that defines the first portion and the second portion. The second sheet may have a first end that is attached to the body, and a second end that is bifurcated to define a third portion configured to be wrapped over an arm of a patient and a fourth portion configured to be wrapped under an arm of a patient.

In some embodiments, the fastening members may be hook and loop fasteners.

In another aspect of the present disclosure, a positioning pad for positioning a patient on an operating table is provided and includes a body, and first sheet and second sheets configured to be coupled to the body. The body has a first end and a second end. The first sheet includes a fastening member disposed on an upper surface of the first sheet and the second sheet includes a fastening member disposed on an upper surface of the second sheet. The first sheet is configured to be wrapped over an arm of a patient and the second sheet is configured to be wrapped under an arm of a patient to secure the fastening members of the first and second sheets to one another and secure the first and second sheets to the arm of the patient.

In some embodiments, the body may have a thickness that increases between the first end of the body and the second end of the body.

In some embodiments, the body may define a first slit spaced from a first lateral side of the body, a second slit spaced from a second lateral side of the body, and a transverse channel interconnecting the first and second slits. The first sheet may include a first end, a second end, and an intermediate portion that interconnects the first end and the second end. In embodiments, the first end extends from the first slit of the body and includes the fastening member, and the second end extends from the second slit of the body and has a fastening member disposed on an upper surface of the second end. The intermediate portion extends through the transverse channel of the body. The second sheet may be configured to be coupled to a bottom surface of the body and have a first end extending from the first lateral side of the body and a second end extending from the second lateral side of the body. The fastening member of the second sheet may be disposed on the first and second ends of the second sheet. The first end of the first sheet may be configured to be secured to the first end of the second sheet and the second end of the first sheet may be configured to be secured to the second end of the second sheet.

In some embodiments, the body may have a fastening member disposed on a bottom surface of the body. The second sheet may have an intermediate portion that interconnects the first and second ends of the second sheet. The intermediate portion of the second sheet may be configured to be attached to the fastening member disposed on the bottom surface of the body.

In yet another aspect of the present disclosure, a head rest for supporting a head of a patient positioned on an operating table is provided and includes a first layer, and a second layer. The first layer has an upper surface configured to receive a head of a patient, and a lower surface. The second layer is removably coupled to the first layer to facilitate selective adjustment of a height of the head rest.

In some embodiments, the head rest may further include a plurality of additional layers removably attached to one another and to a bottom surface of the second layer.

In some embodiments, the head rest may include fastening members formed on one or both of the first and second layers to removably couple the first layer to the second layer. The fastening members may be hook and loop fasteners or adhesives.

In yet another aspect of the present disclosure, a patient positioning kit is provided and includes a body, a sheet configured to be coupled to the body, and a head rest. The sheet is bifurcated to define a first portion and a second portion. The sheet includes a fastening member disposed on the first portion and a fastening member disposed on the second portion. The first portion is configured to be wrapped over an arm of a patient and the second portion is configured to be wrapped under an arm of a patient to secure the fastening member of the first portion to the fastening member of the second portion and secure the sheet to the arm of the patient. The head rest is configured for supporting a head of a patient positioned on an operating table and includes a first layer and a second layer. The first layer has an upper surface configured to receive a head of a patient, and a lower surface. The second layer is removably coupled to the first layer to facilitate selective adjustment of a height of the head rest.

In embodiments, the body may have a first end and a second end and a thickness that increases between the first end of the body and the second end of the body. Alternatively, the body may have a uniform thickness along its length.

In yet another aspect of the present disclosure, a method for positioning a patient on an operating table is provided and includes placing a pad on an operating table. The pad has a body and a first sheet attached to the body. The method further includes positioning a patient on the body of the pad in a supine position, and wrapping the first sheet around an arm of the patient thereby securing the patient to the pad.

In some embodiments, wrapping the first sheet around the arm of the patient may include wrapping a first portion of the first sheet over a right arm of the patient, wrapping a second portion of the first sheet under the right arm of the patient, and securing the first portion of the first sheet to the second portion of the first sheet.

In some embodiments, the method may further include wrapping a third portion of the first sheet over a left arm of the patient, wrapping a fourth portion of the first sheet under the left arm of the patient, and securing the third portion of the first sheet to the fourth portion of the first sheet.

In some embodiments, securing the first portion of the first sheet to the second portion of the first sheet may include attaching a fastening member of the first portion of the first sheet to a fastening member of the second portion of the first sheet.

In some embodiments, the method may further include adjusting a height of a head rest by removing a first layer of the head rest from a second layer of the head rest to lower the height of the head rest, or adding a layer to the head rest to increase the height of the head rest. Removing the first layer of the head rest from the second layer of the head rest may include peeling the second layer away from the first layer to detach a fastening member of the first layer from a fastening member of the second layer.

### BRIEF DESCRIPTION OF THE DRAWINGS

Various embodiments of the presently disclosed positioning system are described herein with reference to the drawings, wherein:

FIG. 1 is a side perspective view of an operating table with a patient shown in phantom secured to the table by the presently disclosed patient positioning system;

FIG. 2 is a side perspective view of the presently disclosed patient positioning system with a sheet positioned within a transverse cut of a positioning pad and remaining parts separated;

FIG. 2A is a side perspective view of the positioning pad and the sheet of the patient positioning system shown in FIG. 2 with a portion of the positioning pad deformed prior to the sheet being positioned within the transverse cut of the positioning pad;

FIG. 3 is a cross-sectional view taken along section line 3-3 of FIG. 1;

FIG. 4 is another embodiment of the presently disclosed patient positioning system;

FIG. 5 is a side view of an alternate embodiment of the positioning pad of the presently disclosed patient positioning system;

FIG. 6 is a side perspective view of an alternate embodiment of the positioning pad of the presently disclosed patient positioning system;

FIG. 6A is a cross-sectional view taken along section line 6A-6A of FIG. 6;

FIG. 7 is a side, perspective view of another embodiment of the positioning pad of the presently disclosed positioning pad system, with a sheet extending through the pad and the pad positioned adjacent an operating table;

FIG. 8 is a side, perspective view of yet another embodiment of the positioning pad of the presently disclosed positioning pad system with a sheet extending through the pad;

FIG. 9 is a side view of the positioning pad shown in FIG. 8;

FIG. 10 is a cross-sectional view of the positioning pad and sheet taken along section lines 10-10 of FIG. 8;

FIG. 11 is a perspective view of another embodiment of a positioning pad;

FIG. 12 is a front view of the positioning pad of FIG. 11;

FIG. 13 is a cross-sectional view of the positioning pad of FIG. 11 illustrating arms of a patient positioned on the positioning pad and secured to an operating table utilizing the positioning pad;

FIG. 14 is a front view of another embodiment of a positioning pad;

FIG. 15 is a perspective view of another embodiment of a positioning pad;

FIG. 16 is a front view of the positioning pad of FIG. 15;

FIG. 17 is a cross-sectional view of the positioning pad of FIG. 15 illustrating arms of a patient positioned on the positioning pad and secured to an operating table utilizing the positioning pad;

FIG. 18A is a perspective view of a head rest with layers of the head rest separated from one another;

FIG. 18B is a perspective view of the head rest of FIG. 18 illustrating the layers of the head rest attached to one another;

FIG. 19A is a perspective view of another embodiment of a head rest illustrating layers of the head rest attached to one another;

FIG. 19B is a top view of the head rest of FIG. 19A; and

FIG. 19C is a side view of the head rest of FIG. 19A.

### DETAILED DESCRIPTION OF EMBODIMENTS

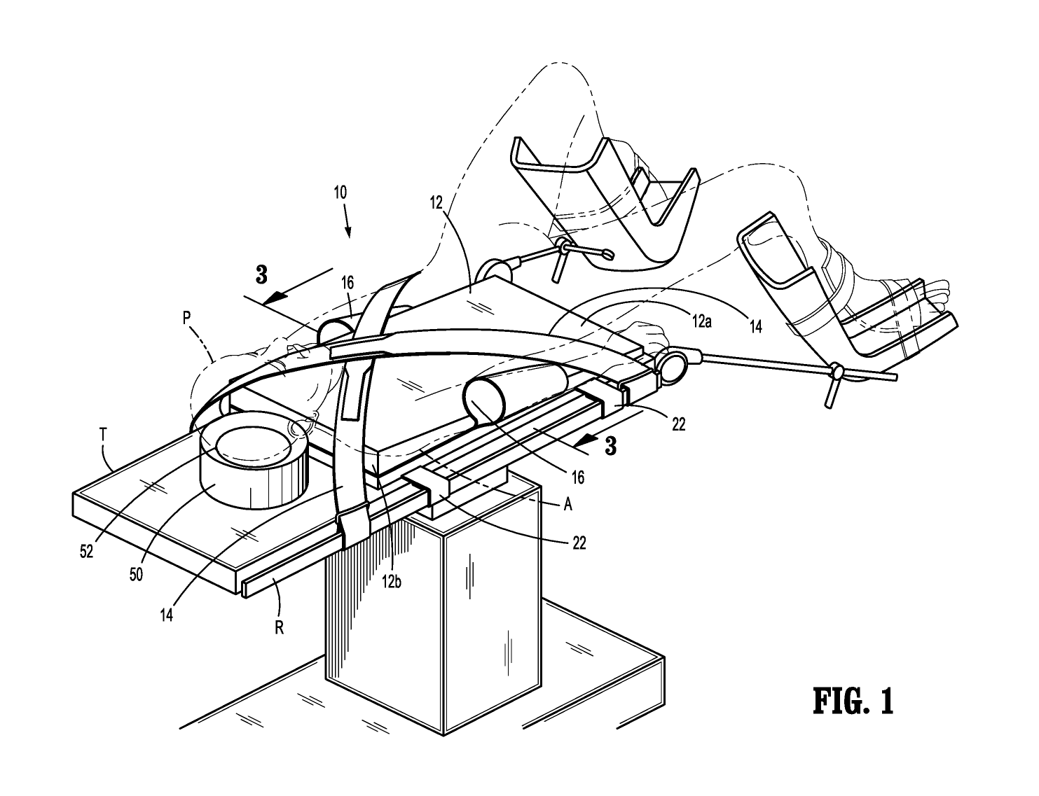

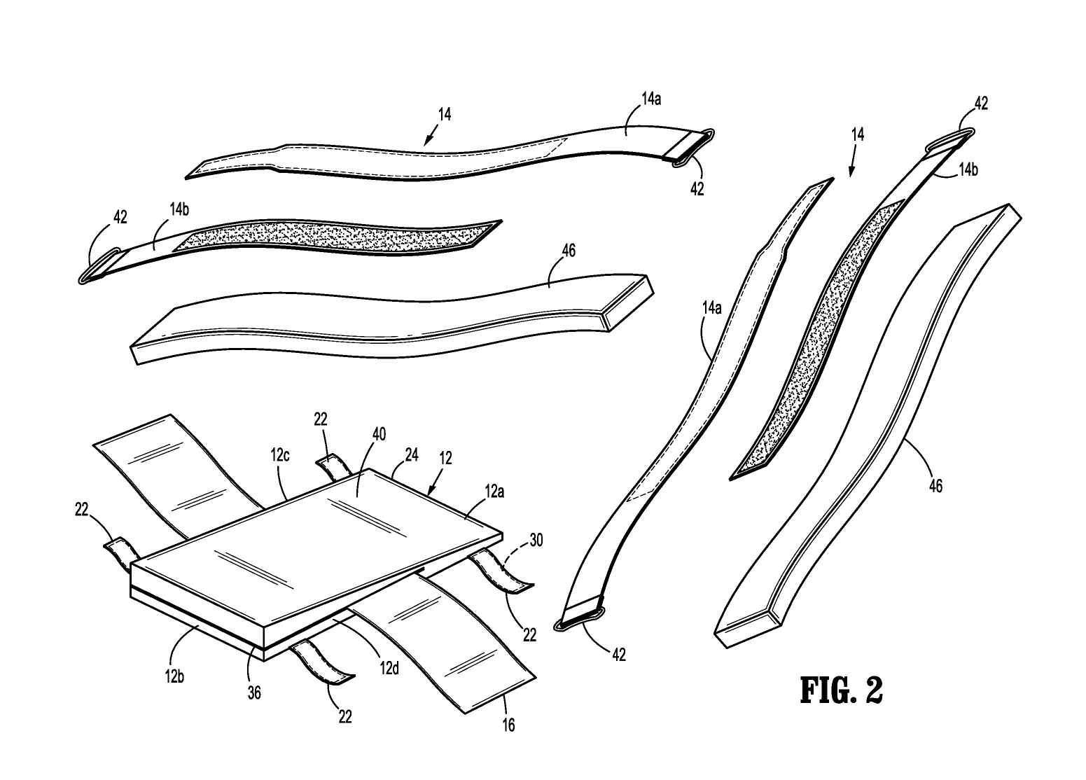

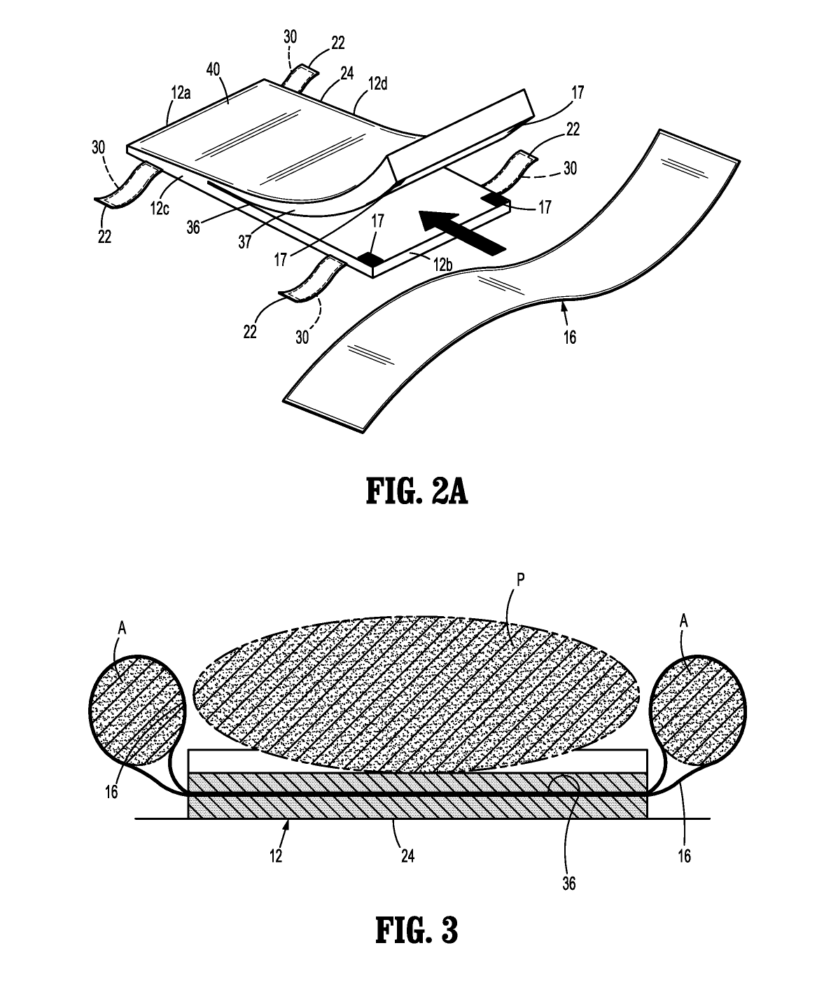

Referring to FIG. 1, the presently disclosed patient positioning system, shown generally as 10, includes a positioning pad 12, at least one strap 14 dimensioned to secure a patient P to an operating table T and a sheet 16. The positioning pad 12 is secured to the operating table T by a plurality of tethers 22. Each of the tethers 22 includes one or more fastening members 30 (FIG. 2), e.g., a buckle or hook and loop fasteners (e.g., Velcro), to facilitate securement of the tether 22 to the operating table T. In one embodiment, a pair of tethers 22 is secured to each end 12a and 12b of the positioning pad 12 by stitching or sewing. Alternately, the tethers 22 can be secured to the positioning pad 12 using other known fastening techniques.

As will be discussed in further detail below, the positioning pad 12 is secured to an operating table T with tethers 22 and a patient P is positioned onto the positioning pad 12. Thereafter, the patient P is secured to the operating table T using the straps 14. The positioning pad 12 is configured to better distribute a patient's weight onto an operating table T when the patient is positioned in an inclined position, e.g., the Trendelenburg position. The positioning pad 12 also is adapted to space the sheet 16 from the patient P to increase the surface area of the patient P which contacts the positioning pad 12 to better immobilize the patient as will be discussed in detail below.

Referring to FIGS. 2 and 2A, the positioning pad 12 includes a body 24 having a thickness which increases from a first end wall 12a of the positioning pad 12 to a second end wall 12b. In one embodiment, the thickness of the pad 12 increases uniformly over the length of the pad 12. Alternately, the pad 12 can have sections of uniform thickness or sections which have a thickness which increases at a faster or slower rate than other sections of the pad 12. The pad 12 is dimensioned to be thicker near the patient's head adjacent the shoulders where the highest amount of pressure is exerted to better redistribute the pressure exerted by the patient P onto the operating table T. In an embodiment, the positioning pad 12 increases in thickness from about one inch at the first end wall 12a to about three inches at the second end wall 12b. Alternatively, other pad thicknesses which may provide more desirable pressure distributions for certain surgical procedures are envisioned.

The positioning pad 12 is formed from a compressible foam material which defines a slip-resistant or tacky surface 40. The foam material can be a visco-elastic foam which conforms to the shape of a patient to minimize or prevent slippage of the patient in relation to the positioning pad 12. In one embodiment, the positioning pad 12 has a width of 20 inches and a length of 32 inches. Alternately, pads 12 having different dimensions to accommodate different size patients or which are more suitable for a specific surgical procedures are envisioned. The positioning pad 12 includes a transverse cut 36 that extends from one side wall 12c of the positioning pad 12 to the other side wall 12d of the positioning pad 12. The transverse cut 36 is dimensioned to receive the sheet 16 to provide separation between the sheet 16 and the patient. More specifically, the transverse cut 36 allows a portion of the positioning pad 12 to be deformed upwardly (FIG. 2A) to allow sheet 16 to pass beneath the patient P while allowing the patient's body to be in full contact with the slip-resistant pad surface 40. As such, a patient P (FIG. 1) can be more securely positioned on and immobilized in relation to the operating table T. As shown in FIG. 2A, a fastening device 17, e.g., hook and loop fasteners, snaps, etc., can be provided to secure a deformable portion 37 of the positioning pad 12 in its undeformed condition after the sheet 16 has been positioned in the transverse cut 36.

In an embodiment, the transverse cut 36 extends from a location spaced from the first end wall 12a through the second end wall 12b. Alternatively, the transverse cut 36 need not extend through the second end wall 12b of the positioning pad 12 but can be spaced from and positioned between the first and second end walls 12a, 12b of the positioning pad 12 or extend through the first end wall 12a of the positioning pad 12 and be spaced from the second end wall 12b.

The tethers 22 are fixedly attached to the positioning pad 12. In the illustrated embodiment, four tethers 22 are secured to the pad 12 with one tether 22 secured at each end of each side wall 12c, 12d of the positioning pad 12. As discussed above, the tethers 22 include a fastening member or members 30, e.g., a buckle or hook and loop fasteners, for securing the tethers to a rail R (FIG. 1) of an operating table T and, thus, fixedly secure the positioning pad 12 to the operating table T.

Referring to FIGS. 1 and 2, in an embodiment, each strap 14 includes a first strap half 14a and a second strap half 14b. One end of each strap half includes a buckle 42 which facilitates securement of the strap half 14 to the rail R of the operating table T. The other end of each strap half 14a, 14b includes a fastening member adapted to engage the fastening member on the other strap half to secure the strap halves 14a, 14b together. In one embodiment, the fastening member includes hook and loop fasteners, e.g., Velcro. Alternately, other fastening members or techniques may be used to secure the strap halves 14a, 14b to each other. In addition, other strap configurations are also envisioned, e. g., the strap can be unitarily formed and attached at each end to the operating table T. Each strap 14 is dimensioned to extend transversely or diagonally across the patient P to secure the patient P to the operating table T as will be discussed in further detail below.

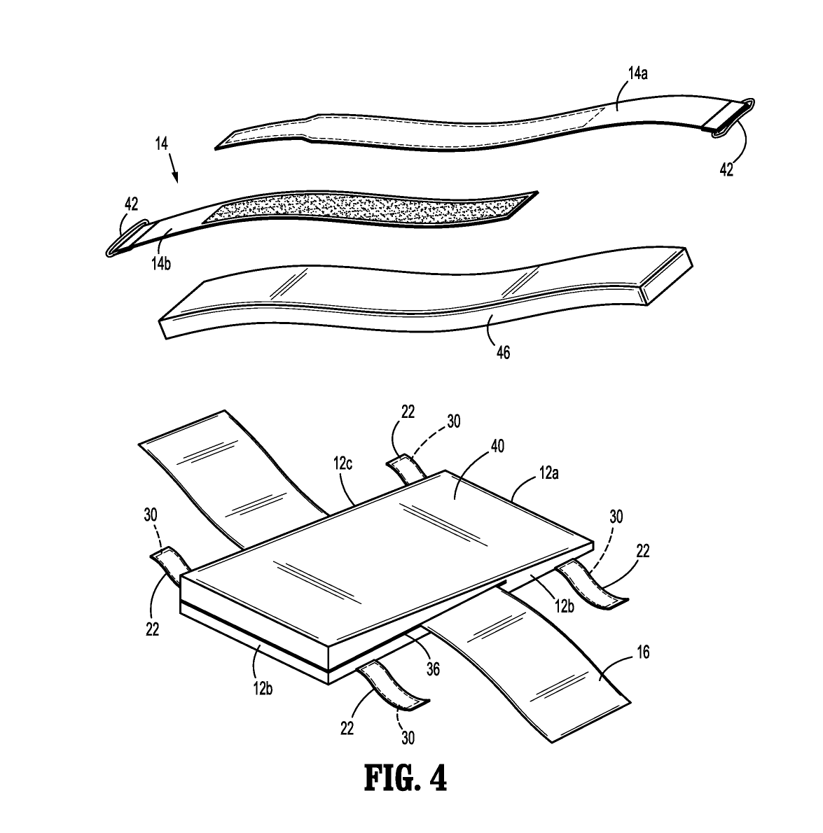

In one embodiment, the patient positioning system 10 includes one or more comfort straps 46 (FIG. 2) which can be positioned between a patient and the strap or straps 14 to prevent patient irritation from the strap 14. In an embodiment, the straps 46 to be positioned between a chest strap 14 (FIG. 4) and a patient P are 34 inches by 6 inches by 2 inches and the straps 46 to be positioned between diagonal straps 14 (FIGS. 1 and 2) and a patient P are 74 inches by 6 inches by 2 inches. The straps 46 can also be positioned between the operating table T and the patient's arms A to more comfortably support the patient P on the operating table T. In an embodiment, these straps are 20 inches by 8 inches by 2 inches. Alternately, comfort straps 46 having a variety of different dimensions are envisioned. The straps 46 can be formed of any suitable material including compressible foam materials or fabrics. Alternately, the use of other materials is envisioned. In an embodiment, the straps 46 have a width which is equal to or larger than the width of the straps 14.

Referring again to FIG. 1, in embodiments, the patient positioning system 10 includes a head rest 50 (FIG. 1). The head rest 50 can include a cylindrical cushion member having an inwardly angled upper wall 52 positioned to support the head of a patient P. Alternately, other head rest configurations are envisioned.

In use, the positioning pad 12 is secured to an operating table T using the tethers 22 which are secured to rails R of the operating table T. When securing a patient T in the Trendelenburg position, the table T will be inclined at an angle of between about 15 degrees and 30 degrees. The positioning pad 12 is secured to the table T such that thicker end 12b is positioned below thinner end 12a. Next, the patient P is positioned on the positioning pad 12 with the patient's shoulders positioned on thicker end 12b of the positioning pad 12 and each end of sheet 16 is folded over an arm A (FIG. 3) of the patient P and tucked into the transverse cut 36 of the positioning pad 12. In an embodiment, the sheet 16 is 80 inches by 15 inches. Alternately, it is envisioned that the sheet 16 can have different dimensions to accommodate a particular patient P. After the sheet 16 is positioned about the patient's arms A, the strap(s) 14 can be secured over the patient to secure the patient to the operating table T. In an embodiment shown in FIG. 1, two diagonally positioned straps 14 can be provided to secure the patient P to the operating table T. Alternately, as shown in FIG. 4, a single strap 14 can be used to secure a patient to the operating table T. The single strap 14 can be positioned to extend from one side of the operating table T across the chest of the patient P to the other side of the operating table T. As discussed above, comfort straps 46 can be positioned between the patient P and the straps 14 or between the patient's arms and the operating table T and the patient's arms A to more comfortably support the patient P on the operating table T. In addition, a head rest 50 can be positioned under the patients head.

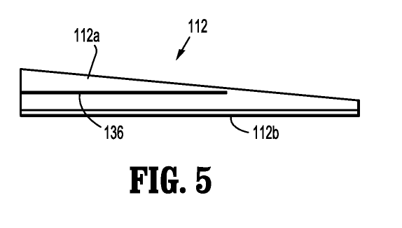

In an embodiment shown in FIG. 5, the pad 112 is formed from two different compressible materials. A first material forms an upper surface 112a of pad 112 which contacts the patient P while a second material forms the lower surface 112b of pad 112 which contacts the operating table (not shown). The transverse cut 136 can be formed in the first material. The first material can be a visco-elastic material. The first and second materials are joined together using, e.g., an adhesive to form a unitary pad 112. In one embodiment, the second material has a higher firmness than the first material. As such, the second material provides structural support to the pad 112 and assists with pressure distribution of the patient on the operating table and the first material has the ability to conform or mold to the patient to prevent slippage. Both materials can be tacky to prevent movement of the pad 112 in relation to the operating table and/or the patient. In an embodiment, the second material can be conventional polyurethane foam and the first material can be visco-elastic foam. Alternately, a single material having both structural and molding qualities can be used to form the pad. Such a material can also be conventional polyurethane foam.

In an embodiment, the Indentation Force Deflection (IFD) of the first material can be between about 9 and 15 and the IFD of the second material can be between about 22 and 40. Alternately, first and second materials having wide IFD ranges are envisioned.

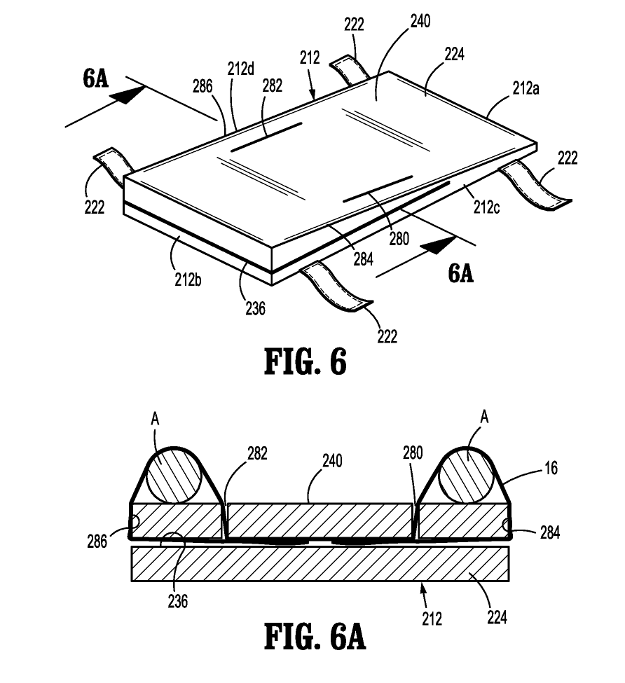

In an alternate embodiment shown in FIGS. 6 and 6A, the positioning pad, shown generally as 212, is substantially the same as positioning pad 12 shown in FIG. 4 and includes a body 224 having a thickness which increases from a first end wall 212a of the positioning pad 212 to a second end wall 212b. The positioning pad 212 is formed from a compressible foam material which defines a slip-resistant or tacky surface 240 and includes a plurality of tethers 222 which are secured to the body 224 at a position to facilitate securement of the positioning pad 212 to an operating table as discussed above.

As discussed above with respect to positioning pad 12, positioning pad 212 defines a transverse cut 236 which extends between sidewalls 212c and 212d of body 224 of pad 212. Positioning pad 212 differs from positioning pad 12 in that body 224 defines two additional slits 280 and 282 which are spaced from side edges 284 and 286 of the body 224 and communicate with the transverse cut 236. Slits 280 and 282 facilitate passage of a sheet 16 through a surface of the body 224 and into the transverse cut 236 of the pad 212 at a location spaced from the edges 284 and 286 of the pad 212.

In use, the sheet 16 can be inserted into the slit 280, through the transverse cut 236, and out of slit 282 such that the sheet 16 is positioned on opposite sides of a patient located on the positioning pad 212. Thereafter, each end of the sheet 16 can be wrapped over a patient's arm A and inserted back into the transverse cut 236 to secure the patient to an operating table. As shown in FIG. 6A, when a patient is secured to an operating table using the positioning pad 212, the patient's arms A rest on the tacky surface 240 of the positioning pad 212.

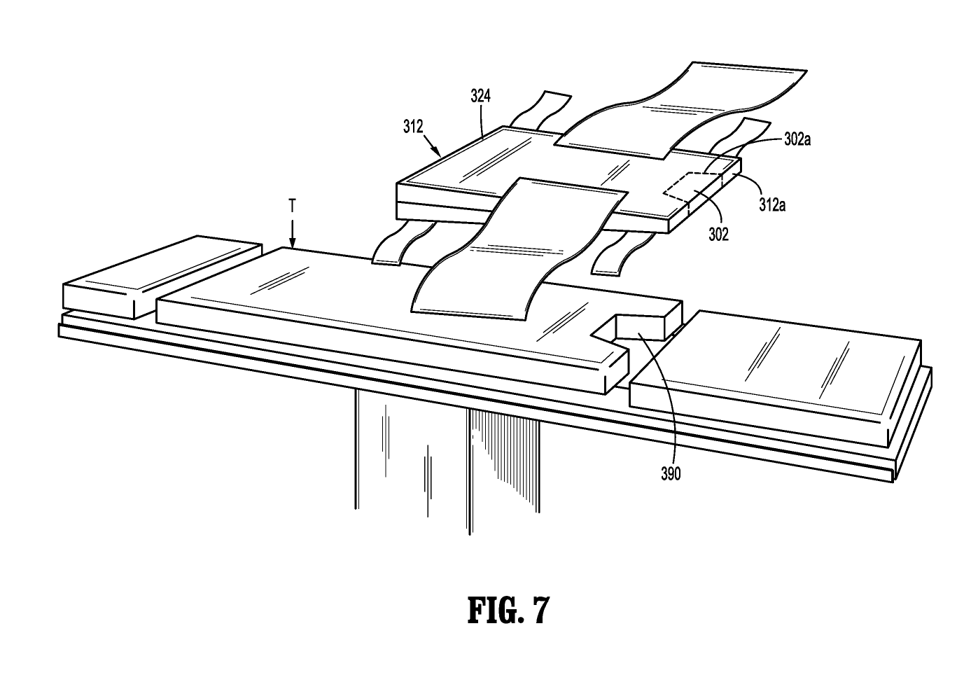

FIG. 7 illustrates the presently disclosed positioning pad system including an alternate embodiment of the positioning pad shown generally as 312. Positioning pad 312 is similar to positioning pad 212 shown in FIGS. 6 and 6A, however, in the positioning pad 312, a perforated section 302 defined by a series of perforations 302a is formed adjacent a first end wall 312a of a body 324. The perforated section 302 is configured to mirror the shape of a perineal cutout 390 formed in some operating tables T. Operating or examining tables used for GYN procedures sometimes utilize a perineal cutout 390 in the table T to facilitate access to the perineum. When using the positioning pad 312 on a table T including a perineal cutout 390, the perforated section 302 can be removed from the positioning pad 312 along the series of perforations 302a so as not to obstruct access to the perineal cutout 390 during a surgical procedure.

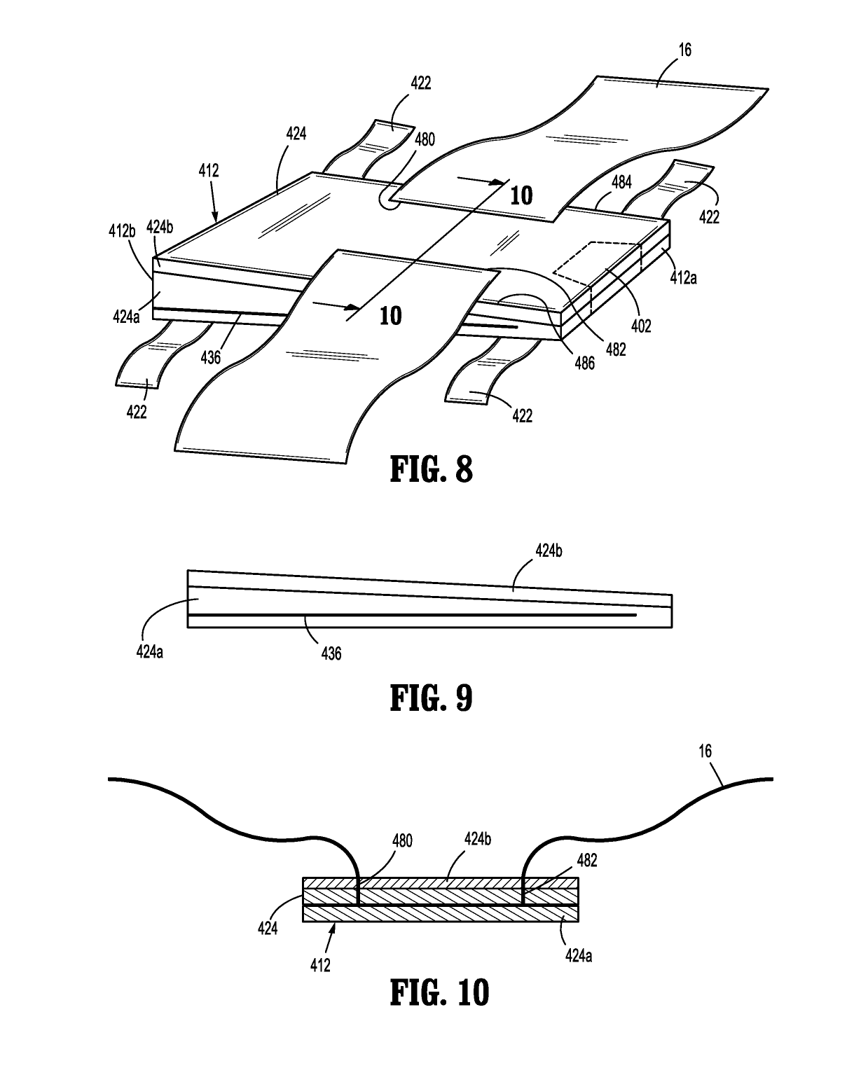

FIGS. 8-10 illustrate another embodiment of a positioning pad 412 of the presently disclosed positioning pad system. Positioning pad 412 is similar to positioning pad 312 shown in FIG. 7 and includes a body 424 having a thickness which increases from a first end wall 412a of the positioning pad 412 to a second end wall 412b. The positioning pad 412 includes a plurality of tethers 422 which are secured to the body 424 at a position to facilitate securement of the positioning pad 412 to an operating table. As discussed above, the positioning pad 412 also defines a transverse cut 436, a perforated section 402, and two additional slits 480 and 482 which are spaced from side edges 484 and 486 of the body 412 and communicate with the transverse cut 436. A sheet 16 is provided to pass through slits 480 and 482 and the transverse cut 436 as discussed above with regard to positioning pad 212. Positioning pad 412 differs from positioning pad 312 in that the body 424 of positioning pad 412 is defined by first and second layers 424a and 424b which are bonded together similar to positioning pad 112. In embodiments, the first layer 424a is a polyurethane foam, e.g., polyurethane foam grade: RA180-023-450, which has a density of 1.80±0.05 pounds per cubic foot, a 25 percent indentation force deflection (IFD) (four inch thickness) of 23±3 lbf, a minimum resilience (ball rebound) of 45 percent, a minimum tensile strength of 12 psi, a minimum elongation of 125 percent, a minimum tear strength of 1.7 pounds of force per linear inch, and a minimum airflow of 2 cubic feet per minute. In embodiments, the second layer 424b is also a polyurethane foam which is bonded to a top surface of the first layer 424a with an adhesive, such as, for example, SABA Aquabond RSD 3801 in combination with SABA Activator 3739 (each available from SABA Dinxperlo BV, Dinxperlo, the Netherlands). In embodiments, the second layer 424b is a polyurethane foam grade: V450-009-000, which has a minimum density of 4.1 pounds per cubic foot, a 25 percent IFD (four inch thickness) of 9±2 lbf, a minimum tensile strength of 3.5 psi, a minimum elongation of 100 percent, and a minimum airflow of two cubic feet per minute. As illustrated, the transverse cut 436 can be formed through the first layer 424a. As discussed above with regard to positioning pad 112, layer 424a can have a higher firmness than layer 424b.

The positioning pad 412 is used in the same manner as the positioning pad 212 and will not be described in further detail herein.

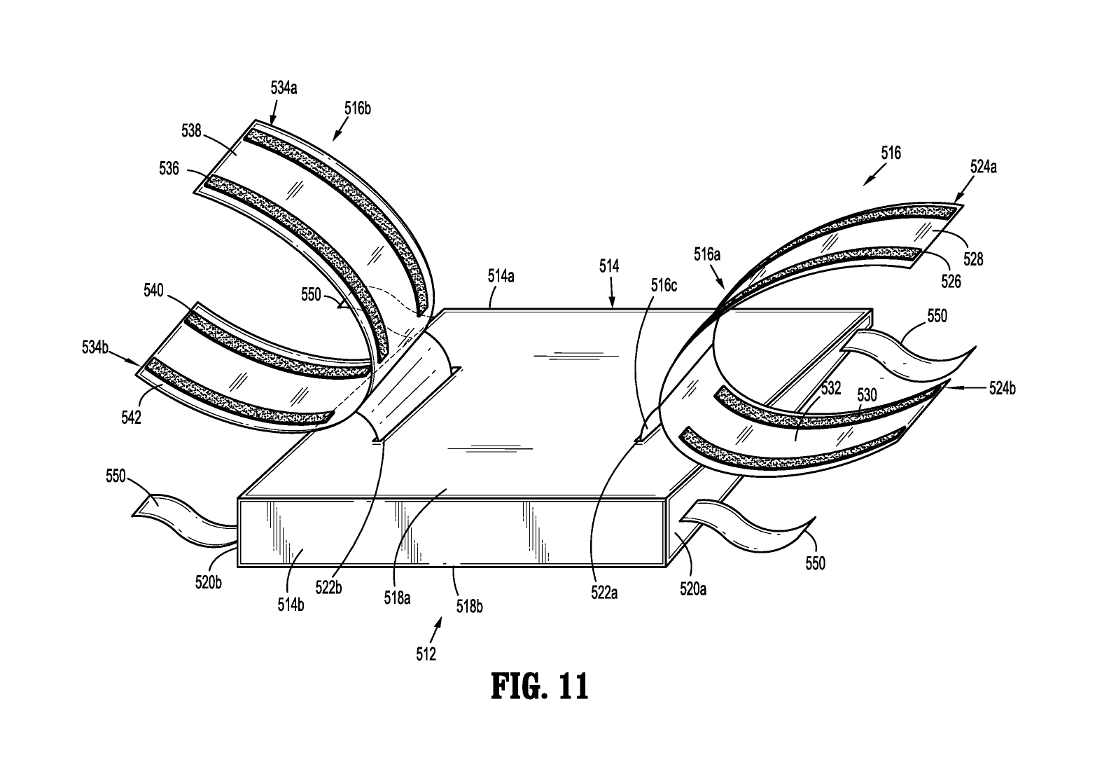

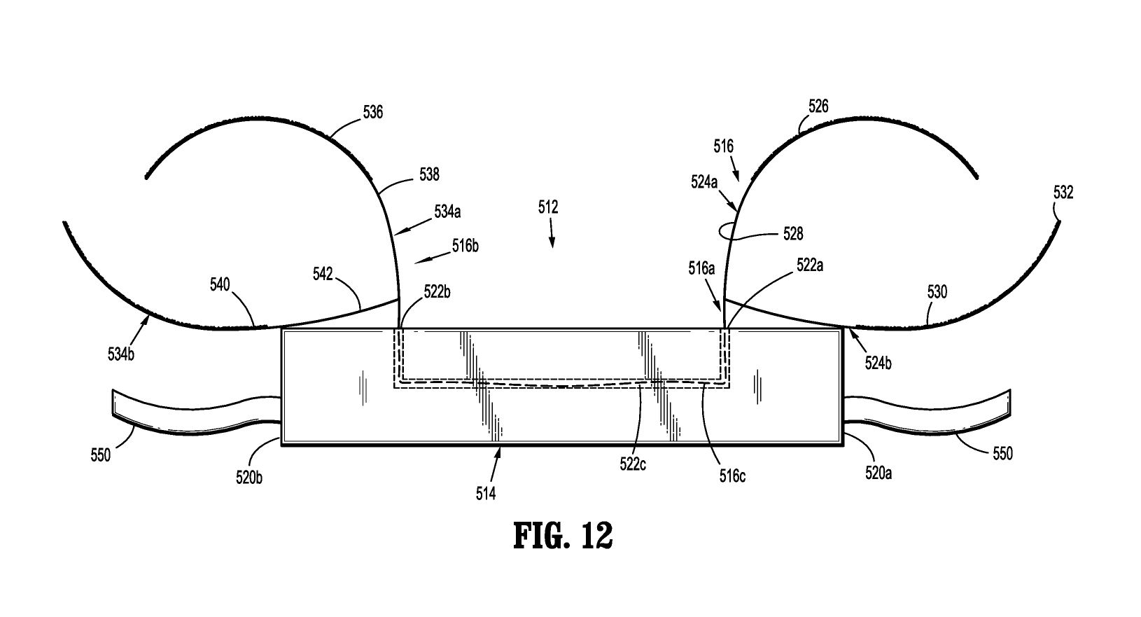

FIGS. 11-13 illustrate another embodiment of a positioning pad 512 of the presently disclosed positioning pad system. Positioning pad 512 is similar to the positioning pads disclosed above, and will therefore only be described in the level of detail necessary to illuminate the differences. Positioning pad 512 generally includes a body 514, and a wrap or sheet 516 configured to be coupled to the body 514. Body 514 has a generally rectangular configuration, but it is contemplated that body 514 may assume any suitable shape conducive to supporting a patient on body 514. Body 514 has a first end 514a and a second end 514b, and may have a thickness that increases from the first end 514a to the second end 514b as described above. Alternatively, the thickness of the body 514 may be uniform along its length. Body 514 further includes a top surface 518a, a bottom surface 518b, a first lateral side 520a, and a second lateral side 520b. Bottom surface 518b is configured to be supported on an operating table, and top surface 518a is configured to support a patient thereon. As described above, in embodiments, the body 514 may have two layers including an upper layer including a visco-elastic foam material and a lower layer including a second material having greater firmness.

In embodiments, body 514 defines a first slit 522a that extends from top surface 518a of body 514 to an interior of body 514. First slit 522a is spaced from first lateral side 520a of body 514 a distance sufficient to allow placement of the arm of a patient on the body 514 between the first slit 522a and the first lateral side 520a of body 514. Body 514 also defines a second slit 522b that extends from top surface 518a of body 514 to the interior of body 514. Second slit 522b is spaced from second lateral side 520b of body 514 a distance sufficient to allow placement of the arm of a patient on the body 514 between the second slit 522b and the second lateral side 520b of body 514. First and second slits 522a, 522b are each configured to receive opposite ends of sheet 516 of pad 512, as will be described in detail below. Body 514 further defines a transverse channel 522c within the interior of body 514 that extends between first and second slits 522a, 522b to form a pathway between first and second slits 522a, 522b. In embodiments, transverse channel 522c may extend between first and second lateral sides 520a, 520b of body 514 such as described above in regard to positioning pads 212, 312, and 412.

With continued reference to FIGS. 11-13, sheet 516 is pliable, but it is contemplated that sheet 516 may assume a variety of structural characteristics, such as, for example, strap-like, tether-like, rope-like, ribbon-like, belt-like or cuff-like. Sheet 516 is configured to be coupled to the body 514 by passing sheet 516 through first slit 522a, into transverse channel 522c, and out of second slit 522b defined in body 514. It is contemplated that sheet 516 may be slidably disposed within transverse channel 522c and removable therefrom, or permanently fixed within transverse channel 522c. Sheet 516 has a first end 516a that extends from first slit 522a of body 514, a second end 516b that extends from second slit 522b of body 514, and an intermediate portion 516c that interconnects first and second ends 516a, 516b and extends through transverse channel 522c of body 514.

First end 516a of sheet 516 is bifurcated to define a first portion 524a and a second portion 524b. First portion 524a of bifurcated first end 516a has a length that provides first portion 524a with the capability of being wrapped over an arm of a patient. Second portion 524b of bifurcated first end 516a has a length that provides second portion 524b with the capability of being wrapped under an arm of a patient. Bifurcated first end 516a of sheet 516 has a fastening member 526 disposed on an upper surface 528 of first portion 524a and a fastening member 530 disposed on an upper surface 532 of second portion 524b. Fastening members 526, 530 may include buckles, hook and loop fasteners (e.g., Velcro), adhesives, or any suitable fastening member configured to detachable connect fastening member 526 of first portion 524a to fastening member 530 of second portion 524b to secure the sheet 516 about the arms of a patient, and thus, secure the patient to the positioning pad 512.

Second end 516b of sheet 516, like first end 516a of sheet 516, is bifurcated to define a third portion 534a and a fourth portion 534b of second end 516b of sheet 516. Third portion 534a of bifurcated second end 516b has a length that provides third portion 534a with the capability of being wrapped over an arm of a patient. Fourth portion 534b of bifurcated second end 516b has a length that provides fourth portion 534b with the capability of being wrapped under an arm of a patient. Bifurcated second end 516b of sheet 516 has a fastening member 536, similar to fastening member 528, disposed on an upper surface 538 of third portion 534a and a fastening member 540 disposed on an upper surface 542 of fourth portion 534b.

In some embodiments, the top surface and/or a bottom surface of one or all of first, second, third, and fourth portions 524a, 524b, 534a, 534b of bifurcated ends 516a, 516b may have a fastening member. It is contemplated that sheet 516 may be attached to and extend along bottom surface 518b of body 514 rather than be disposed within transverse channel 522c defined in body 514.

Positioning pad 512 may also include a plurality of tethers 550 at opposite ends of the pad 512 to secure the pad 512 to an operating table. The plurality of tethers 550 are substantially described above with regard to tethers 222 and will not be described in further detail herein. It is also envisioned that first and second ends 516a, 516b of sheet 516 may be dimensioned to extend about a rail or support surface of the operating table to secure the pad 512 and patient to the table.

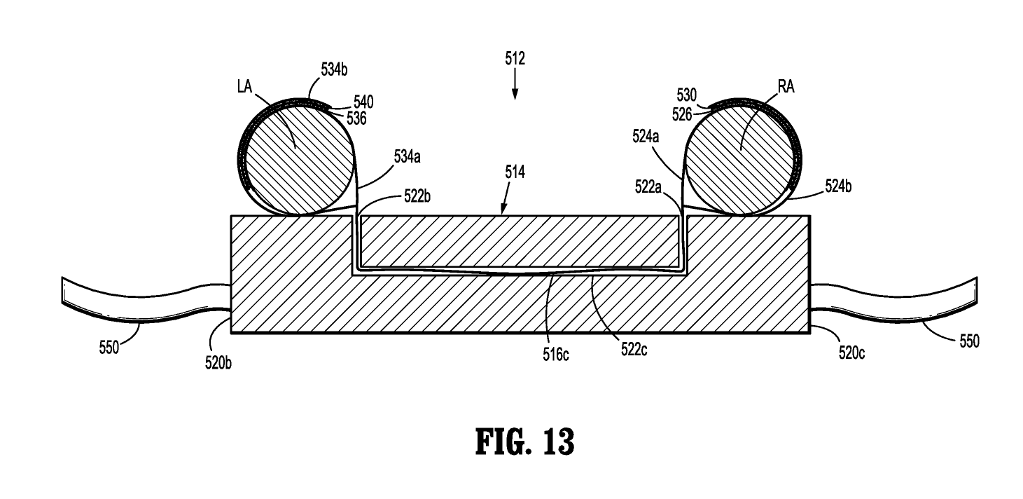

In use, with reference to FIG. 13, pad 512 is positioned on an operating table (not explicitly shown), and a patient is positioned on body 514 of pad 512 in a supine position. A right arm “RA” of the patient is supported on body 514 of pad 512 at a location of body 514 between first slit 522a and first lateral side 520a, and a left arm “LA” of the patient is supported on body 514 of pad 512 at a location between second slit 522b and second lateral side 520b. First portion 524a of first end 516a of sheet 516 is positioned between the right arm “RA” and torso (not shown) of the patient, and wrapped over right arm “RA” of the patient. Second portion 524b of first end 516a of sheet 516 is manipulated under the right arm “RA” of the patient and wrapped over first portion 524a of sheet 516 to attach fastening member 530 of second portion 524b to fastening member 526 of first portion 524a and secure the right arm “RA” of the patient to the pad 512. Left arm “LA” of the patient is secured to pad 512 using second end 516b of sheet 516 in a similar manner as right arm “RA” as described above.

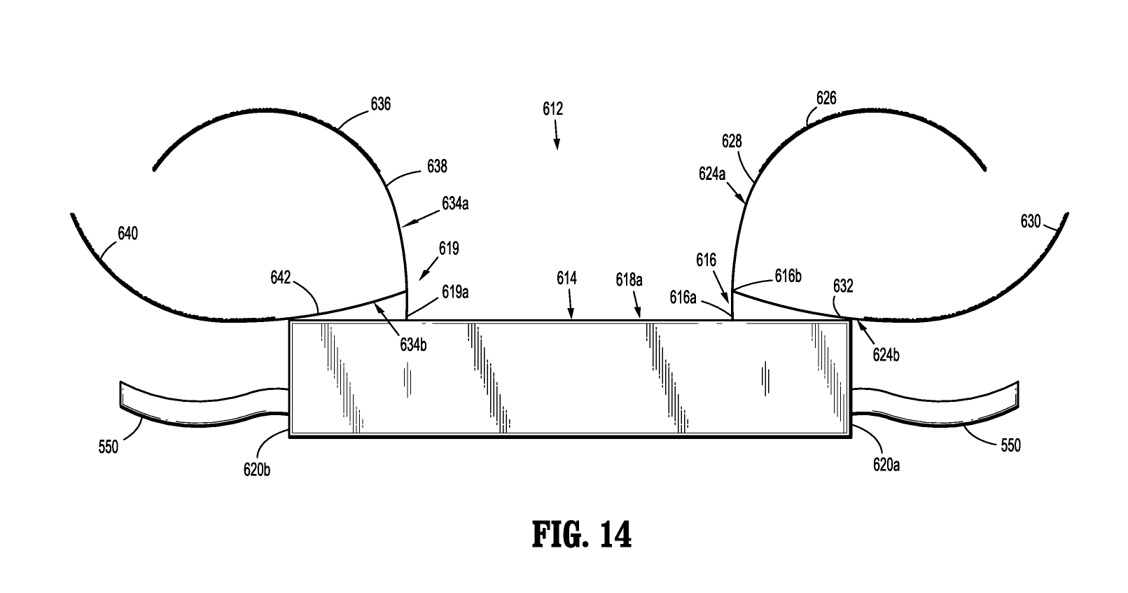

FIG. 14 illustrates another embodiment of a positioning pad 612 of the presently disclosed positioning pad system. Positioning pad 612 is similar to positioning pad 512 disclosed above, and will therefore only be described in the level of detail necessary to illuminate the differences. Pad 612 includes a body 614, a first sheet 616, and a second sheet 619. Pad 612 is different than pad 512 in that pad 612 has two separate sheets that are individually attached to a top surface 618a of pad 612, rather than including a single sheet that extends through an interior of body 614.

First sheet 616 is attached to top surface 618a at a location spaced from a first lateral side 620a of body 614, and second sheet 619 is attached to top surface 618a of body 614 at a location spaced from a second lateral side 620b of body 614, opposite first lateral side 620a of body 614. First and second sheets 616, 619, like sheet 516 of pad 512, are each bifurcated and have fastening members for selectively fastening the bifurcated ends to one another.

In particular, first sheet 616 has a first end 616a attached to body 614 of positioning pad 612, and a bifurcated second end 616b that defines a first portion 624a and a second portion 624b. Pad 612 includes a fastening member 626 disposed on an upper surface 628 of first portion 624a and a fastening member 630 disposed on an upper surface 632 of second portion 624b.

Second sheet 619 has a first end 619a attached to body 614 of positioning pad 612, and a bifurcated second end 619b that defines a third portion 634a and a fourth portion 634b. Pad 612 includes a fastening member 636 disposed on an upper surface 638 of third portion 634a and a fastening member 640 disposed on an upper surface 642 of fourth portion 634b.

Pad 612 is utilized to support a patient thereon and to secure a patient to the positioning pad 612 in a similar fashion as pad 512 described with reference to FIG. 13, and therefore will not be described in further detail herein.

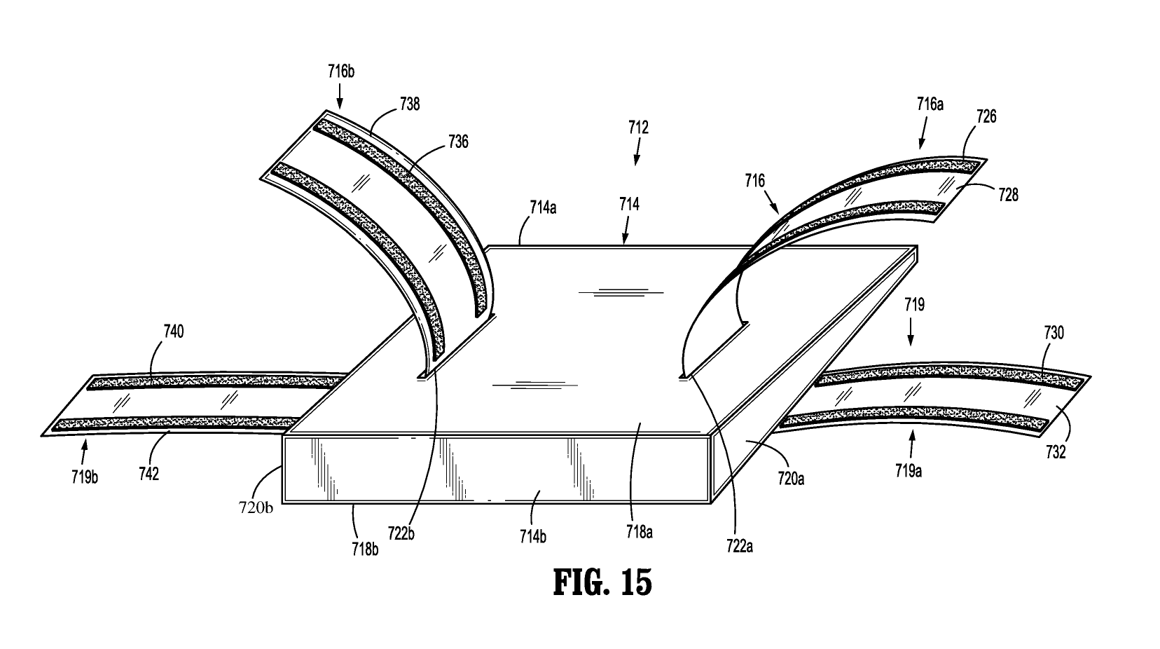

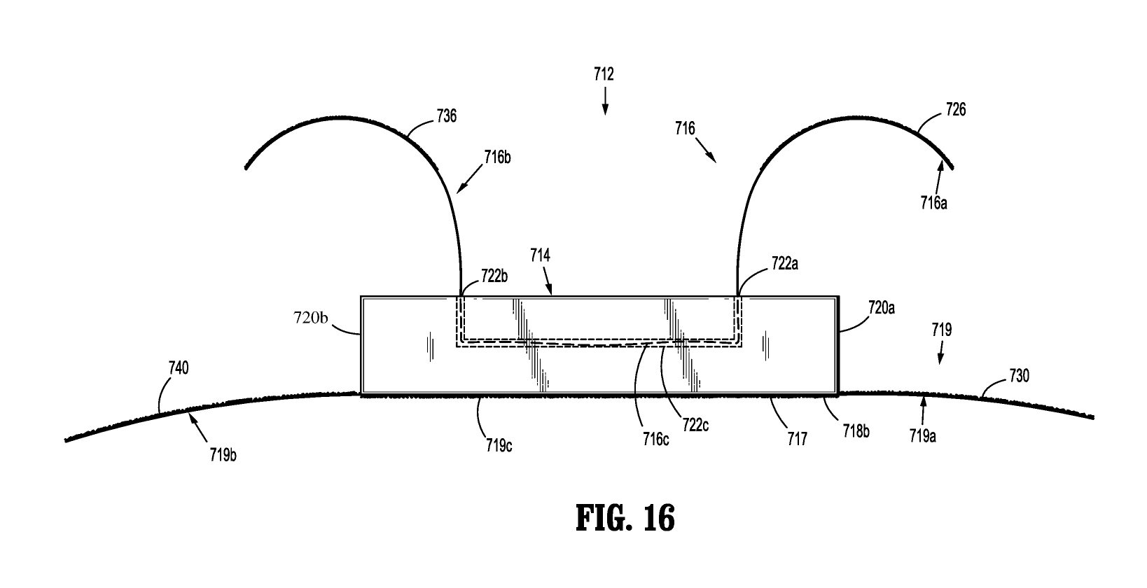

FIGS. 15-17 illustrate yet another embodiment of a positioning pad 712 of the presently disclosed positioning pad system. Positioning pad 712 is similar to positioning pad 512 disclosed above, and will therefore only be described in a level of detail necessary to illuminate the differences. Positioning pad 712 includes a body 714, a first sheet 716 configured to be coupled to the body 714, and a second sheet 719 also configured to be coupled to the body 714.

Body 714 of pad 712 may have a first end 714a and a second end 714b, and a thickness that increases from the first end 714a to the second end 714b as described above. Alternatively, the thickness of the body 714 may be uniform along its length. Body 714 further includes a top surface 718a, a bottom surface 718b, a first lateral side 720a, and a second lateral side 720b. Bottom surface 718b is configured to be supported on an operating table, and top surface 718a is configured to support a patient thereon. Body 714, unlike body 514 described above with reference to FIGS. 11-13, has a fastening member 717 (see FIG. 1) disposed on bottom surface 718b thereof, which is configured to selectively fasten second sheet 719 thereto, as will be described.

In embodiments, body 714 defines a first slit 722a that extends from top surface 718a of body 714 to an interior of body 714. First slit 722a is spaced from first lateral side 720a of body 714. Body 714 defines a second slit 722b that also extends from top surface 718a of body 714 to the interior of body 714. Second slit 722b is spaced from second lateral side 720b of body 714. First and second slits 722a, 722b are each configured to receive opposite ends 716a, 716b of first sheet 716 of pad 712, as will be described in detail below. Body 714 further defines a transverse channel 722c within the interior of body 714. Transverse channel 722c extends between first and second slits 722a, 722b to form a pathway between first and second slits 722a, 722b. In embodiments, transverse channel 722c may extend between first and second lateral sides 720a, 720b of body 714.

First and second sheets 716, 719 are pliable , but it is contemplated that first and second sheets 716, 719 may assume a variety of structural characteristics, such as, for example, strap-like, tether-like, rope-like, ribbon-like, belt-like or cuff-like. First sheet 716 of pad 712 is configured to be coupled to the body 714 by passing first sheet 716 through first slit 722a, into transverse channel 722c, and out of second slit 722b defined in body 714. It is contemplated that first sheet 716 may be slidably disposed within transverse channel 722c and removable therefrom, or permanently fixed within transverse channel 722c. First sheet 716 has a first end 716a that extends from first slit 722a of body 714, a second end 716b that extends from second slit 722b of body 714, and an intermediate portion 716c that interconnects first and second ends 716a, 716b and extends through transverse channel 722c of body 714.

First end 716a of first sheet 716 has a fastening member 726 disposed on an upper surface 728 thereof. Second end 716b of first sheet 716 also has a fastening member 736 disposed on an upper surface 738 thereof. Fastening members 736, 738 may include buckles, hook and loop fasteners, adhesives, or any suitable fastening member.

Second sheet 719 of pad 712 is configured to be detachably coupled to bottom surface 718b of body 714. In some embodiments, second sheet 719 may be permanently attached to bottom surface 718b of body 714 or may extend through an interior of body 714. Second sheet 719 has a first end 719a, a second end 719b, and an intermediate portion 719c that interconnects first and second ends 719a, 719b of second sheet 719. It is contemplated that first and second ends 719a, 719b of second sheet 719 may be individual sheets configured to be attached to opposite lateral sides of body 714 without being interconnected with an intermediate portion. Intermediate portion 719c has a fastening member (not explicitly shown) configured to detachably connect to fastening member 717 of bottom surface 718b of body 714.

First end 719a of second sheet 719 extends laterally from first lateral side 720a of body 714, and second end 719b of second sheet 719 extends laterally from second lateral side 720b of body 714. Second sheet 719 has a fastening member 730 disposed on an upper surface 732 of first end 719a of second sheet 719 such that first end 716a of first sheet 716 and first end 719a of second sheet 719 are configured to be detachably connected to one another. Second sheet 719 also has a fastening member 740 disposed on an upper surface 742 of second end 719b of second sheet 719 such that second end 716b of first sheet 716 and second end 719b of second sheet 719 are configured to be detachably connected to one another, as will be described in detail below.

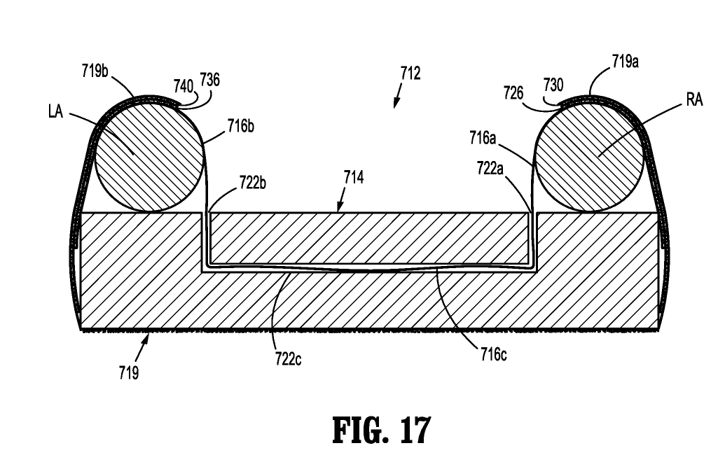

In use, with reference to FIG. 17, pad 712 is positioned on an operating table (not explicitly shown), and a patient is positioned on body 714 of pad 712 in a supine position. A right arm “RA” of the patient is supported on body 714 of pad 712 at a location of body 714 between first slit 722a and first lateral side 720a, and a left arm “LA” of the patient is supported on body 714 of pad 712 at a location between second slit 722b and second lateral side 720b. First end 716a of first sheet 716 is positioned between the right arm “RA” and torso (not shown) of the patient, and wrapped over the right arm “RA” of the patient. First end 719a of second sheet 719 is wrapped over the right arm “RA” of the patient and first end 716a of first sheet 716 to attach fastening member 730 of first end 719a of second sheet 719 to fastening member 726 of first end 716a of first sheet 716 and secure the right arm “RA” of the patient to the pad 712. The left arm “LA” of the patient is secured to pad 712 with second end 719b of second sheet 719 and second end 716b of first sheet 716 in a similar manner as the right arm “RA,” and will therefore not be described in further detail.

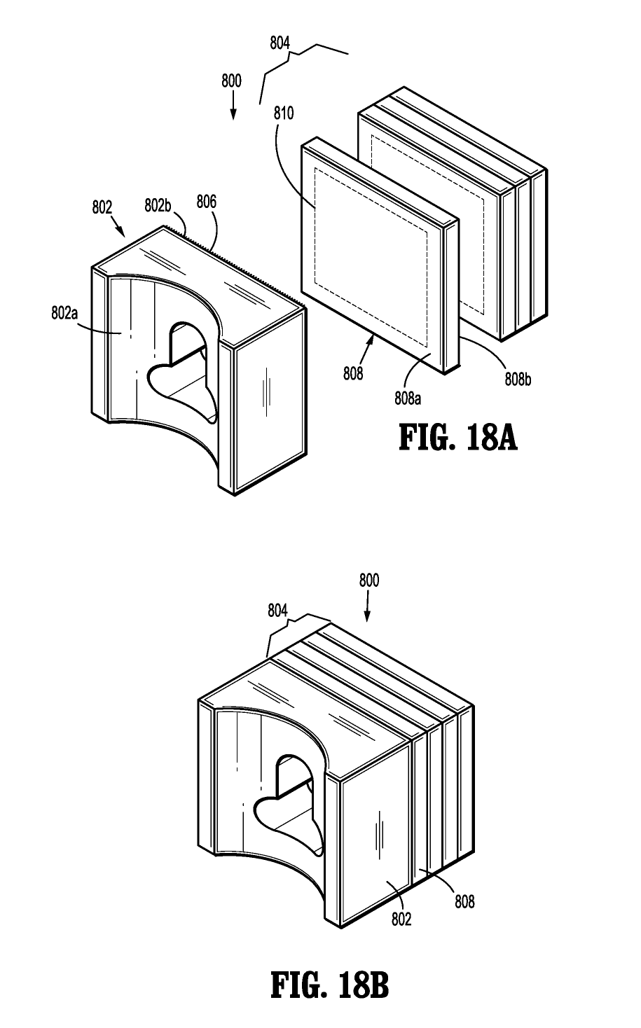

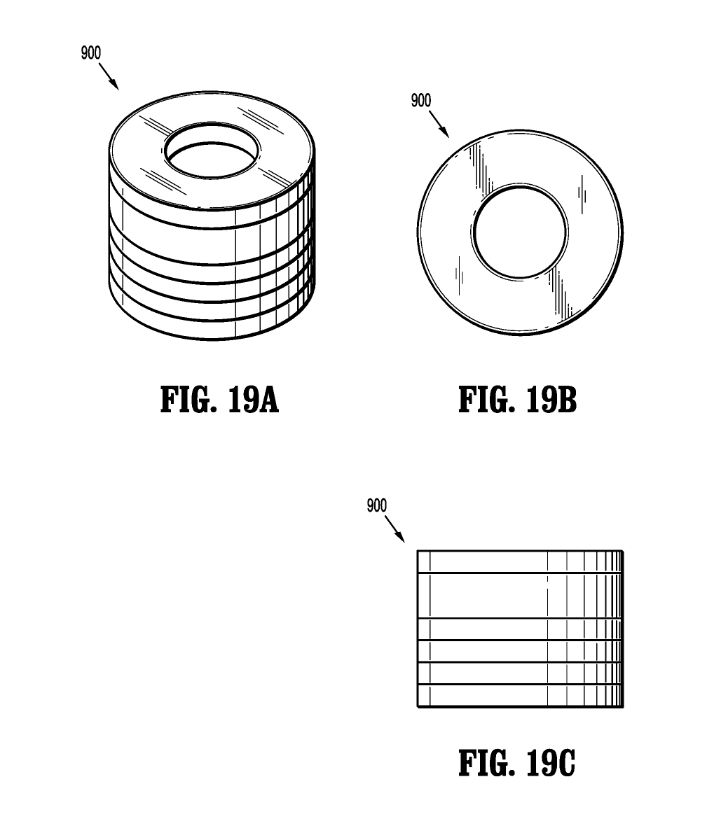

With reference to FIGS. 18A-19C, the positioning pad system may further include a head rest for supporting a head of a patient when the patient is supported on any of the disclosed pads in the supine position. Head rests 800, 900 of FIGS. 18A-19C are each capable of having their height selectively adjusted, as will be described in detail below.

With reference to FIGS. 18A and 18B, one embodiment of a head rest 800 is illustrated, which has a generally rectangular configuration and includes a first or top layer 802, and a plurality of second layers 804. As illustrated in FIGS. 19A-19C, another embodiment of a head rest 900 has a circular configuration. It is contemplated that head rests 800, 900 may assume any suitable shape.

Top layer 802 of head rest 800 has an upper surface 802a configured to receive and support a head and/or neck of a patient, and a lower surface 802b. Top layer 802 has a fastening member 806 disposed on lower surface 802b of top layer 802. It is contemplated that fastening member 806 may be an adhesive, a hook and loop fastener, or any suitable fastening member disclosed above. Each of the plurality of second layers 804, for example, a second layer 808 has a fastening member 810 disposed on an upper surface 808a thereof such that upper surface 808a of second layer 808 is removably attached to lower surface 802b of first layer 802. Second layer 808 has another fastening member (not explicitly shown) disposed on a bottom surface 808b thereof such that additional layers of the head rest 800 may be attached thereto. Where adhesives are used to releasably secure the layers together, the adhesive need only be provided on one of the two layers prior to engagement of the layers.

Head rest 900 illustrated in FIGS. 19A-19C is substantially similar to head rest 800, and will therefore not be described in any further detail.

In use, when supporting a head of a patient on head rest 800 or head rest 900, the height of the head rest 800, 900 may need to be adjusted depending on the size of the patient. To lower the height of head rest 800 or 900, second layer 804 is peeled away from first layer 802 to detach the second layer 804 from the first layer 802. To increase the height of head rest 800, one of the plurality of secondary layers 804 of head rest 800 may be attached to bottom surface 808b of second layer 808.

In some embodiments, any of the pads disclosed herein may be provided with head rest 800 or head rest 900 in the form of a kit.

Persons skilled in the art will understand that the devices and methods specifically described herein and illustrated in the accompanying drawings are non-limiting exemplary embodiments. It is envisioned that the elements and features illustrated or described in connection with one exemplary embodiment may be combined with the elements and features of another without departing from the scope of the present disclosure. As well, one skilled in the art will appreciate further features and advantages of the disclosure based on the above-described embodiments. Accordingly, the disclosure is not to be limited by what has been particularly shown and described, except as indicated by the appended claims.

What is claimed is:

1. A positioning pad for positioning a patient on an operating table, comprising:
a body having a first end and a second end; and
at least one sheet configured to be coupled to the body, the at least one sheet being bifurcated to define a first portion and a second portion, the at least one sheet including a fastening member disposed on the first portion and a fastening member disposed on the second portion, wherein the first portion is configured to be wrapped over an arm of a patient and the second portion is configured to be wrapped under an arm of a patient to secure the fastening member of the first portion to the fastening member of the second portion and secure the sheet to the arm of the patient.

2. The positioning pad according to claim 1, wherein the body has a thickness that increases between the first end of the body and the second end of the body.

3. The positioning pad according to claim 1, wherein the body defines a first slit, a second slit, and a transverse channel interconnecting the first and second slits, the at least one sheet configured to extend through the first slit of the body, through the transverse channel of the body, and through the second slit of the body.

4. The positioning pad according to claim 3, wherein the at least one sheet includes:
a first end extending from the first slit of the body;
a second end extending from the second slit of the body; and
an intermediate portion that interconnects the first end and the second end and that extends through the transverse channel of the body, the first end of the at least one sheet being bifurcated to define the first portion and the second portion.

5. The positioning pad according to claim 4, wherein the second end of the at least one sheet is bifurcated to define a third portion and a fourth portion of the at least one sheet, the third portion being configured to be wrapped over an arm of a patient and the fourth portion being configured to be wrapped under an arm of the patient.

6. The positioning pad according to claim 1, wherein the at least one sheet includes a first sheet and a second sheet, the first sheet being attached to the body at a location adjacent a first lateral side of the body, the second sheet being attached to the body at a location adjacent a second lateral side of the body.

7. The positioning pad according to claim 6, wherein the first sheet has a first end attached to the body, and a second end defining the first portion and the second portion, the second sheet having a first end that is attached to the body, and a second end that is bifurcated to define a third portion configured to be wrapped over an arm of a patient and a fourth portion configured to be wrapped under an arm of a patient.

8. The positioning pad of claim 1, wherein the fastening members are each hook and loop fasteners.

9. A positioning pad for positioning a patient on an operating table, comprising:
a body having a first end and a second end; and
a first sheet configured to be coupled to the body and including a fastening member disposed on an upper surface of the first sheet; and
a second sheet configured to be coupled to the body and including a fastening member disposed on an upper surface of the second sheet, wherein the first sheet is configured to be wrapped over an arm of a patient and the second sheet is configured to be wrapped under an arm of a patient to secure the fastening members of the first and second sheets to one another and secure the first and second sheets to the arm of the patient.

10. The positioning pad according to claim 9, wherein the body has a thickness that increases between the first end of the body and the second end of the body.

11. The positioning pad according to claim 9, wherein the body defines a first slit spaced from a first lateral side of the body, a second slit spaced from a second lateral side of the body, and a transverse channel interconnecting the first and second slits.

12. The positioning pad according to claim 11, wherein the first sheet includes:
a first end extending from the first slit of the body and including the fastening member;
a second end extending from the second slit of the body and having a fastening member disposed on an upper surface of the second end; and
an intermediate portion that interconnects the first end and the second end and that extends through the transverse channel of the body.

13. The positioning pad according to claim 12, wherein the second sheet is configured to be coupled to a bottom surface of the body, the second sheet having a first end extending from the first lateral side of the body, and a second end extending from the second lateral side of the body, the fastening member of the second sheet disposed on the first and second ends of the second sheet.

14. The positioning pad of claim 13, wherein the first end of the first sheet is configured to be secured to the first end of the second sheet and the second end of the first sheet is configured to be secured to the second end of the second sheet.

15. The positioning pad according to claim 13, wherein the body has a fastening member disposed on a bottom surface of the body, the second sheet having an intermediate portion that interconnects the first and second ends of the second sheet, the intermediate portion of the second sheet configured to be attached to the fastening member disposed on the bottom surface of the body.

16. A head rest for supporting a head of a patient positioned on an operating table, comprising:
a first layer having an upper surface configured to receive a head of a patient, and a lower surface; and
a second layer removably coupled to the first layer, the second layer being removable from the first layer to facilitate selective adjustment of a height of the head rest.

17. The head rest of claim 16, further comprising a plurality of additional layers removably attached to one another and to a bottom surface of the second layer.

18. The head rest according to claim 16, further comprising fastening members formed on at least one of the first or second layers to removably couple the first layer to the second layer, wherein the fastening members are selected from hook and loop fasteners and adhesives.
